(19) United States
(12) Patent Application Publication
(10) Pub. No.: US 2018/0062138 A1
(43) Pub. Date: Mar. 1, 2018

(54) METHOD OF PRODUCING NONAQUEOUS ELECTROLYTE SECONDARY BATTERY SEPARATOR

(71) Applicant: Sumitomo Chemical Company, Limited, Tokyo (JP)

(72) Inventors: Eiko KASHIWAZAKI, Osaka (JP); Chikara MURAKAMI, Osaka (JP)

(21) Appl. No.: 15/677,193

(22) Filed: Aug. 15, 2017

(30) Foreign Application Priority Data
Aug. 31, 2016 (JP) 2016-170104

(51) Int. Cl. H01M 2/14; C08J 5/18; H01M 10/05

(52) U.S. Cl. CPC H01M 2/145; H01M 10/05; C08J 5/18

(57) ABSTRACT

A method of producing a nonaqueous electrolyte secondary battery separator capable of realizing a nonaqueous electrolyte secondary battery having a higher rate-characteristic-maintenance property is provided. A porous film containing polyolefin as a main component is immersed in a polar solvent at no greater than 100° C.

This Nonprovisional application claims priority under 35 U.S.C. §119 on Patent Application No. 2016-170104 filed in Japan on Aug. 31, 2016, the entire contents of which are hereby incorporated by reference.

### TECHNICAL FIELD

The present invention relates to a method of producing a nonaqueous electrolyte secondary battery separator.

### BACKGROUND ART

Nonaqueous electrolyte secondary batteries such as lithium secondary batteries have high energy density and accordingly are widely used as batteries for devices such as personal computers, mobile phones, and portable information terminals. Furthermore, recently, the nonaqueous electrolyte secondary batteries have been developed as on-vehicle batteries.

As a separator for a nonaqueous electrolyte secondary battery, a porous film containing polyolefin as a main component is used.

Recently, a nonaqueous electrolyte secondary battery is required to show further higher performance. In order to improve performance of a separator, there is proposed an improvement of a porous film containing polyolefin as a main component.

Patent Literature 1 discloses that, in order to provide a porous film which is less likely to contract by heat and has an excellent low temperature shutdown characteristic and a high porosity, a porous film containing high molecular weight polyolefin is immersed in a poor solvent at a temperature not lower than (melting point of the high molecular weight polyolefin −15° C.) and not more than (the melting point +5° C.) so that the porous film is subjected to a heat-setting process.

### CITATION LIST

### Patent Literature

[Patent Literature 1]

Japanese Patent Application Publication Tokukai No. 2000-256499 (Publication date: Sep. 19, 2000)

### SUMMARY OF INVENTION

### Technical Problem

However, nonaqueous electrolyte secondary batteries including conventional nonaqueous electrolyte secondary battery separators, including the nonaqueous electrolyte secondary battery separator disclosed in Patent Literature 1, suffer a problem that such nonaqueous electrolyte secondary batteries do not have a sufficiently high rate-characteristic-maintenance property after repeated charge-discharge cycles.

The present invention was made in view of the foregoing problem. An object of the present invention is to provide a method of producing a nonaqueous electrolyte secondary battery separator capable of realizing a nonaqueous electrolyte secondary battery having a higher rate-characteristic-maintenance property after repeated charge-discharge cycles.

### Solution to Problem

In order to solve the foregoing problem, a method for producing a nonaqueous electrolyte secondary battery separator in accordance with an embodiment of the present invention includes the step of immersing a porous film containing polyolefin as a main component in a non-protonic polar solvent at no greater than 100° C., so as to modify the porous film.

It is preferable to arrange the method in accordance with an embodiment of the present invention such that the non-protonic polar solvent is at a temperature of 30° C. to 100° C.

It is preferable to arrange the method in accordance with an embodiment of the present invention such that the porous film is immersed while the polar solvent in contact with a surface of the porous film is renewed.

The method in accordance with an embodiment of the present invention may further include the step of removing, from the porous film having been immersed in the non-protonic polar solvent at no greater than 100° C., the polar solvent, in the step of removing the polar solvent, the porous film having been immersed in the polar solvent being immersed in a solvent different from the polar solvent.

It is preferable to arrange the method in accordance with an embodiment of the present invention so as to further include the step of removing, from the porous film having been immersed in the non-protonic polar solvent at no greater than 100° C., the polar solvent, in the step of removing the polar solvent, a gas in contact with a surface of the porous film having been immersed in the polar solvent being renewed.

The method in accordance with an embodiment of the present invention may be arranged such that the gas is a nitrogen gas.

### Advantageous Effects of Invention

As described above, the method of producing a nonaqueous electrolyte secondary battery separator in accordance with an embodiment of the present invention includes the step of immersing a porous film containing polyolefin as a main component in a non-protonic polar solvent so as to modify the porous film. This yields an effect that a nonaqueous electrolyte secondary battery prepared using the nonaqueous electrolyte secondary battery separator in accordance with an embodiment of the present invention has a high rate-characteristic-maintenance property after repeated charge-discharge cycles.

### DESCRIPTION OF EMBODIMENTS

The following description will discuss an embodiment of the present invention in detail. Note that unless specified otherwise, any numerical range expressed as “A to B” herein means “not less than A and not greater than B”.

As a result of diligent study to solve the foregoing problem, the inventors of the present invention have found that in a case where a porous film containing polyolefin as a main component is immersed in a non-protonic polar solvent at no greater than 100° C. so as to obtain a porous film and the obtained porous film is used as a separator for a nonaqueous electrolyte secondary battery, the nonaqueous electrolyte secondary battery surprisingly has a higher rate-characteristic-maintenance property after charge-discharge cycles than a nonaqueous electrolyte secondary battery using a porous film having not been immersed in the solvent.

Immersion of a porous layer in the non-protonic polar solvent at no greater than 100° C. enables the rate-characteristic-maintenance property after charge-discharge cycles to be higher for the reasons below. Specifically, immersion of a porous layer containing polyolefin as a main component in the non-protonic polar solvent at no greater than 100° C. causes a resin on surfaces of pore walls of the porous film to be swollen to an appropriate extent and be deformed, which disturbs crystallinity and orientation of the resin on the surface and changes a structure of the pores. Furthermore, at the same time, (i) active sites having an affinity for ions such as radicals and polar functional groups which are generated in a process of producing the porous film, such as the time of film formation, and which are present on surfaces of pore walls of the porous film and (ii) molecules of a solvent form a coordination complex and are stabilized. Disturbance of crystallinity and orientation of the resin on the surface of the pore walls makes it easier for an electrolyte to enter the fine pores. Together with this easiness, a change in a structure of pores and stabilization of the active sites having an affinity for ions make it easier for ions to move in the pores of a separator when a nonaqueous electrolyte secondary battery using the immersed porous film as a separator operates, so that the separator has higher ion permeability. This reduces a load on the separator and the electrolyte when the battery operates, thereby subduing a decrease in rate characteristic due to repetition of charge-discharge cycles.

As described above, the present invention was made on the finding that, in a case where a porous film containing polyolefin as a main component is immersed in a non-protonic polar solvent at no greater than 100° C., a nonaqueous electrolyte secondary battery using the porous film as a separator can be modified to have a higher rate-characteristic-maintenance property after charge-discharge cycles.

That is, a method of producing a nonaqueous electrolyte secondary battery separator in accordance with an embodiment of the present invention includes the step of immersing a porous film containing polyolefin as a main component in a non-protonic polar solvent at no greater than 100° C. so as to modify the porous film.

(I) Porous Film

A porous film containing polyolefin as a main component is a finely porous layer which contains a polyolefin as a main component and which has many pores therein, the pores being connected to one another, so that a gas or a liquid can pass through the porous layer from one surface of the porous layer to the other. p The expression “containing polyolefin as a main component” herein means that polyolefin is contained in the porous film at a proportion of preferably not less than 50% by weight, more preferably not less than 90% by weight, and still more preferably not less than 95% by weight of an entire weight of the porous film.

Pores of the porous film have an average pore diameter preferably in a range of 0.010 μm to 0.30 μm. The average pore diameter being not less than 0.010 μm is preferable because, with such an average pore diameter, a nonaqueous electrolyte secondary battery separator using the porous film can secure ion permeability. Furthermore, the average pore diameter being not greater than 0.30 μm is preferable because, with such an average pore diameter, particles having dropped from a cathode and/or anode can be prevented from entering into the pores. The average pore diameter is more preferably not less than 0.015 μm, and still more preferably not less than 0.020 μm. The upper limit of the average pore diameter is more preferably not greater than 0.15 μm, and still more preferably not greater than 0.10 μm.

Furthermore, porosity of the porous film is preferably 20% by volume to 80% by volume. The porosity being not less than 20% by volume is preferable because, with such porosity, the nonaqueous electrolyte secondary battery separator using the porous film can secure sufficient ion permeability. Furthermore, the porosity being not greater than 80% by volume is preferable because, with such porosity, the separator can secure a sufficient strength. The porosity is more preferably being not less than 25% by volume, and still more preferably not less than 30% by volume. Furthermore, the upper limit of the porosity is more preferably not greater than 70% by volume and still more preferably not greater than 60% by volume.

Air permeability of the porous film in terms of Gurley values is preferably 30 sec/100 cc to 500 sec/100 cc, and more preferably 50 sec/100 cc to 350 sec/100 cc. The air permeability of the porous film falling within these ranges is preferable because sufficient ion permeability can be imparted to a nonaqueous electrolyte secondary battery separator using the porous film as a separator.

A thickness of the porous film is preferably 4 μm to 40 μm. The thickness of the porous film being not less than 4 μm is preferable because, with such a thickness, an internal short circuit of the battery, which internal short circuit is caused by breakage or the like of the battery, can be sufficiently prevented in a nonaqueous electrolyte secondary battery which uses the porous film. Furthermore, the thickness of the porous film being not greater than 40 μm is preferable because, with such a thickness, it is possible to restrict an increase in resistance to permeation of ions. The thickness of the porous film is more preferably not less than 6 μm, and still more preferably not less than 8 μm. Furthermore, the upper limit of the thickness of the porous film is more preferably not greater than 30 μm, and still more preferably not greater than 25 μm.

Examples of polyolefin used in the present invention encompass, but not particularly limited to, homopolymers (such as polyethylene, polypropylene, polybutene, polypentene, polyhexane etc.) and copolymers (such as ethylene-propylene copolymer, ethylene-butene copolymer, propylene-butene copolymer etc.) produced through polymerization of at least one olefin monomer selected from ethylene, propylene, 1-butene, 4-methyl-1-pentene, and 1-hexene. The polyolefin is more preferably polyethylene in view of the fact that polyethylene can prevent (shutdown) the flow of an excessively large current at a lower temperature. Examples of the polyethylene encompass low-density polyethylene, high-density polyethylene, linear polyethylene (ethylene-α-olefin copolymer), ultra-high molecular weight polyethylene having weight average molecular weight of not less than 1,000,000.

Although a molecular weight of the polyolefin is not particularly limited, it is more preferable that the polyolefin contains a high molecular weight component having a weight average molecular weight of preferably not less than 3×10⁵ and not greater than 2×10⁷, still more preferably not less than 5×10⁵ and not greater than 15×10⁶. The weight average molecular weight being not less than 3×10⁵ is preferable in terms of a balance between s shape maintenance property at heating and a shutdown performance. Containing a high molecular weight component having a weight average molecular weight of 1,000,000 is more preferable because, with such a weight average molecular weight, (i) a nonaqueous electrolyte secondary battery separator which is the porous film and (ii) a nonaqueous electrolyte secondary battery laminated separator which is a laminate including the porous film have higher strengths.

Examples of the method of producing the porous film encompass, but are not particularly limited to, a method in which a pore-forming agent is added to a resin such as polyolefin to form a film and then the pore-forming agent is removed with a proper solvent.

Specifically, for example, in a case of producing a porous film containing a ultra-high molecular weight polyethylene and a low molecular weight polyolefin whose weight average molecular weight is not greater than 10,000, a production method including the steps (1) through (5) below can be used properly. The order of the steps (3) and (4) may be changed.

(1) Kneading 100 parts by mass of ultra-high molecular weight polyethylene, 5-200 parts by mass of low molecular weight polyolefin whose weight average molecular weight is not greater than 10,000, and 100-400 parts by mass of a pore-forming agent to obtain a polyolefin resin composition.

(2) Rolling the polyolefin resin composition to form a rolled sheet.

(3) Removing the pore-forming agent from the rolled sheet obtained in the step (2).

(4) Stretching the sheet from which the pore-forming agent has been removed in the step (3).

(5) Thermally fixing the sheet having been stretched in the step (4) at a thermally fixing temperature of not less than 100° C. and not greater than 150° C. to obtain a porous film.

Examples of the pore-forming agent include, but are not limited to: inorganic filler agents such as inorganic fillers which are soluble in a water-based solvent containing acid, a water-based solvent containing alkaline, and a water-based solvent mainly made of water, respectively; and plasticizers made of low molecular weight hydrocarbon etc., such as liquid paraffin.

The porous film may contain other component, provided that the objective of the present invention is not impaired. Examples of the other component include an anti-oxidation agent, a dispersing agent, and a plasticizer.

The porous film may be obtained by laminating two or more layers of porous films.

(II) Immersing Step

The method of producing a nonaqueous electrolyte secondary battery separator in accordance with an embodiment of the present invention includes the step of immersing the aforementioned porous film in a non-protonic polar solvent at no greater than 100° C. to modify the porous film.

The following description will discuss the step of immersing the aforementioned porous film in a non-protonic polar solvent at no greater than 100° C.

The solvent used in this step is not particularly limited, provided that the solvent is a non-protonic polar solvent. Examples of the non-protonic polar solvent encompass acetone, diethylketone, methyl isobutyl ketone, N-methyl-2-pyrrolidone, dimethylacetamide, dimethylformamide, dimethyl carbonate, diethyl carbonate, ethylene carbonate, propylene carbonate, dimethyl sulfoxide, sulfolane, acetonitrile, and a mixture of two or more of them. By immersing the aforementioned porous film in the non-protonic polar solvent, a nonaqueous electrolyte secondary battery using the porous film as a separator can prevent a decrease in rate characteristic due to repetition of charge-discharge cycles.

This makes it possible to realize a nonaqueous electrolyte secondary battery having a high rate-characteristic-maintenance property.

The polar solvent used herein indicates a solvent whose difference between logP (calculated value of fat-solubility) and logS (calculated value of water-solubility) is not greater than 2.40. logP and logS can be calculated with use of ChemDraw (CambridgeSoft, molecule editor software). That is, the modification in the present embodiment can be made by immersion into a solvent having appropriate fat-solubility (i.e. hydrophobicity) and hydrophilicity.

The following shows logP, logS, and a difference Δ (logP−logS) for some examples of the non-protonic polar solvent.

Acetone: logP=0.2, logS=−0.13, Δ(logP−logS)=0.33

N-methyl-2-pyrrolidone: logP=−0.34, logS=−0.28, Δ(logP−logS)=−0.06
N,N-dimethylacetamide: logP=−0.49, logS=−0.01, Δ(logP−logS)=−0.48
Diethyl carbonate: logP=1.22, logS=−1.04, Δ(logP−logS)=2.26
Ethylene carbonate: logP=0.30, logS=−0.49, Δ(logP−logS)=0.79
Propylene carbonate: logP=0.62, logS=−0.85, Δ(logP−logS)=1.47
sulfolane: logP=−0.78, logS=−1.20, Δ(logP−logS)=0.42

In contrast to the above example of the polar solvent, for example, chloroform (logP=1.01, logS=−1.43, Δ(logP−logS)=2.44), methylene chloride (logP=1.67, logS=−2.06, Δ(logP−logS)=3.73) etc. have A(logP−logS) which is larger than 2.40, and are not encompassed in the polar solvent in the present invention.

A temperature of the non-protonic polar solvent to immerse the porous film should be not greater than 100° C. Such a temperature allows a nonaqueous electrolyte secondary battery using the immersed porous film as a separator to prevent a decrease in rate characteristic due to repetition of charge-discharge cycles. The temperature of the non-protonic polar solvent in which the porous film is to be immersed is more preferably 30° C. to 100° C., and still more preferably 30° C. to 90° C., and particularly preferably 30° C. to 85° C.

A period of time for which the porous film is to be immersed in the non-protonic polar solvent is, for example, 1 second to 100 hours.

“Modification” used herein indicates changing a porous film containing polyolefin as a main component in such a manner that a nonaqueous electrolyte secondary battery using the porous film as a separator has an improved rate-characteristic-maintenance property after repeated charge-discharge cycles. To be more specific, “modification” is, for example, such that the rate characteristic after 100 cycles described in later-mentioned Examples is larger than that in a case where the porous film is not immersed in a non-protonic polar solvent at not greater than 100° C. More specifically, “modification” is such that the rate characteristic after 100 cycles is larger preferably by 4%, more preferably by 8%, than that in a case where the porous film is not immersed in a non-protonic polar solvent at not greater than 100° C.

In the method of producing a nonaqueous electrolyte secondary battery separator, it is more preferable to immerse the porous film while renewing the polar solvent in contact with a surface of the porous film. This allows making the modification efficiently. Examples of a method of renewing the polar solvent in contact with the surface of the porous film encompass, but are not limited to, a method of convecting the polar solvent in an immersion tank by heating, a method of stirring the polar solvent in an immersion tank by a stirrer, a method of circulating the polar solvent in an immersion tank by pump circulation, and a method of always supplying the polar solvent to an immersion tank so that the polar solvent is overflowed.

(III) Polar Solvent Removal Step

It is more preferable that the method of producing a nonaqueous electrolyte secondary battery separator, in accordance with an embodiment of the present invention further includes the step of removing a polar solvent from the porous film having been immersed in the polar solvent.

In this step, a method of removing a polar solvent from the porous film having been immersed in the polar solvent is not particularly limited. An example of the method is removal of the polar solvent by evaporation. Examples of a method of removal by evaporation encompass natural drying, air blow drying, and drying under reduced pressure. A temperature at which the polar solvent is removed by evaporation is not particularly limited, provided that the temperature is not greater than 100° C. The temperature is preferably 10° C. to 95° C., and more preferably 30° C. to 90° C. The temperature being not greater than 100° C. is preferable because such a temperature does not impair the effect of the present invention.

In the method of producing a nonaqueous electrolyte secondary battery separator in accordance with an embodiment of the present invention, when removing the polar solvent, it is preferable to renew a gas in contact with a surface of the porous film having been immersed in the polar solvent. Such a method is preferable because such a method allows efficiently removing the polar solvent, thereby subduing deformation of pores, particularly surface openings, of a porous film due to a change in volume of the solvent in evaporation, a capillary force etc.

Examples of the gas to be in contact with the surface of the porous film having been immersed in the polar solvent encompass, but are not limited to, air, a nitrogen gas, an argon gas, and a mixture gas of two or more of them. Among them, in terms of costs and disaster prevention, it is preferable to use, as the aforementioned gas, nitrogen or a mixture gas of air and nitrogen.

The method of renewing a gas to be in contact with the surface of the porous film having been immersed in the polar solvent encompass, but are not limited to, a method of renewing, by air blow drying, the gas to be in contact with the surface of the porous film, a method of renewing, by drying under reduced pressure, the gas to be in contact with the surface of the porous film, and a method of renewing, by circulating a gas phase in a tank, the gas to be in contact with the surface of the porous film.

In the method of producing a nonaqueous electrolyte secondary battery separator in accordance with an embodiment of the present invention, the polar solvent may be removed by causing the porous film having been immersed in the polar solvent to be immersed in a solvent different from the polar solvent.

Furthermore, replacing the polar solvent with a different solvent which is more easily removable makes it possible to efficiently remove the polar solvent.

Examples of a method of causing the porous film having been immersed in the polar solvent to be immersed in a solvent different from the polar solvent encompass (i) a method of discharging the polar solvent from an immersion tank and then introducing the different solvent into the immersion tank, (ii) a method of introducing the different solvent into an immersion tank of the polar solvent so as to replace the polar solvent with the different solvent, and (iii) a method of taking out, from an immersion tank, the porous film having been immersed in the polar solvent and cleaning the porous film with the different solvent.

An example of a solvent usable as the solvent different from the polar solvent is an easily volatile solvent. More specific examples of the solvent different from the polar solvent encompass acetone, diethylether, n-hexane, and methanol.

The easily volatile solvent used herein may be any solvent, provided that it has a boiling point lower than that of the solvent in which the porous film is immersed in an immersion step. The easily volatile solvent is more preferably a solvent which has a boiling point lower than that of the solvent in which the porous film is immersed in an immersion step and whose vapor pressure at 20° C. is not less than 4 kPa.

A porous film obtained by causing the porous film having been immersed in the polar solvent to be immersed in the solvent different from the polar solvent is more preferably subjected to removal of the different solvent from the porous film. The method of removing the different solvent can be carried out in a manner similar to that of the step of removing the polar solvent from the porous film.

The present invention is not limited to the embodiments, but can be altered by a skilled person in the art within the scope of the claims. An embodiment derived from a proper combination of technical means each disclosed in a different embodiment is also encompassed in the technical scope of the present invention.

### EXAMPLES

The following description will discuss the present invention more specifically with reference to Examples. It should be noted that the present invention is not limited to Examples.

<Method of Measuring Physical Properties>

Physical properties of nonaqueous electrolyte secondary battery separators produced in Examples and Comparative Examples were measured as follows.

(Rate Characteristic After Charge-Discharge Cycle)

A nonaqueous electrolyte secondary battery having been produced as described later was subjected to four cycles of initial charge and discharge, each cycle of which was carried out (i) at 25° C., (ii) at a voltage ranging from 4.1 V to 2.7 V, and (iii) at a current value of 0.2 C. Note that 1 C is defined as a value of an electric current at which a rated capacity based on a discharge capacity at 1 hour rate is discharged for 1 hour. The same applies to the following description.

The nonaqueous electrolyte secondary battery having been subjected to the initial charge and discharge was subjected to 100 cycles of charge and discharge, each cycle of which was carried out at 55° C., at a voltage ranging from 4.3 V to 2.7 V, with a constant current having a charge current value of 1 C, and a discharge current value of 10 C.

The nonaqueous electrolyte secondary battery having been subjected to 100 cycles of the charge and discharge was subjected to three cycles of charge and discharge at 55° C. with a constant current having (i) a charge current value of 1 C and (ii) a discharge current value of 0.2 C or 10 C. Then, a ratio of a discharge capacity at a third cycle when the discharge current value was 0.2 C to a discharge capacity at a third cycle when the discharge current value was 10 C (10 C discharge capacity/0.2 C discharge capacity) was calculated as a rate characteristic after 100 cycles of charge and discharge (rate characteristic after 100 cycles).

<Production of Nonaqueous Electrolyte Secondary Battery Separator>

Porous films in accordance with Examples 1 through 9 and Comparative Examples 1 through 6, which were to be used as nonaqueous electrolyte secondary battery separators, were produced as follows.

### Comparative Example 1

A polyethylene porous film (A) (of 12 μm in thickness and 39% in porosity) was used as a nonaqueous electrolyte secondary battery separator in Comparative Example 1.

### Example 1

The polyethylene porous film in Comparative Example 1 was immersed for 1 hour in acetone kept at 40° C. At that time, a liquid (acetone) in contact with a surface of the polyethylene porous film was constantly renewed by convection by heating. Then, the polyethylene porous film was taken out from acetone, and then was left still in a draft controlled to have a suction wind speed of 0.4 m/sec. and was dried therein. Thus, a nonaqueous electrolyte secondary battery separator in Example 1 was obtained.

### Example 2

The polyethylene porous film in Comparative Example 1 was immersed for 5 minutes in acetone kept at 40° C. At that time, a liquid (acetone) in contact with a surface of the polyethylene porous film was constantly renewed by convection by heating. Then, the polyethylene porous film was taken out from acetone, and then was left still in a draft controlled to have a suction wind speed of 0.4 m/sec. and was dried therein. Thus, a nonaqueous electrolyte secondary battery separator in Example 2 was obtained.

### Example 3

The polyethylene porous film in Comparative Example 1 was immersed for 90 hours in N-methyl-2-pyrrolidone kept at 80° C. At that time, a liquid (N-methyl-2-pyrrolidone) in contact with a surface of the polyethylene porous film was constantly renewed by convection by heating. Then, the polyethylene porous film was taken out from N-methyl-2-pyrrolidone, and was immersed in acetone so that N-methyl-2-pyrrolidone was replaced with acetone. Then, the polyethylene porous film was taken out from acetone, and then was left still in a draft controlled to have a suction wind speed of 0.4 m/sec. and was dried therein. Thus, a nonaqueous electrolyte secondary battery separator in Example 3 was obtained.

### Example 4

The polyethylene porous film in Comparative Example 1 was immersed for 1 hour in N-methyl-2-pyrrolidone kept at 80° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 4 was obtained.

### Example 5

The polyethylene porous film in Comparative Example 1 was immersed for 5 minutes in N-methyl-2-pyrrolidone kept at 80° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 5 was obtained.

### Comparative Example 2

The polyethylene porous film in Comparative Example 1 was immersed for 10 minutes in N-methyl-2-pyrrolidone kept at 125° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Comparative Example 2 was obtained.

### Comparative Example 3

The polyethylene porous film in Comparative Example 1 was immersed for 1 hour in N-methyl-2-pyrrolidone kept at 125° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Comparative Example 3 was obtained.

### Comparative Example 4

A polyethylene porous film (B) (of 20 μm in thickness and 52% in porosity) was used as a nonaqueous electrolyte secondary battery separator in Comparative Example 4.

### Comparative Example 5

A polyethylene porous film (C) (of 15 μm in thickness and 48% in porosity) was used as a nonaqueous electrolyte secondary battery separator in Comparative Example 5.

### Example 6

The polyethylene porous film in Comparative Example 4 was immersed for 90 hours in N-methyl-2-pyrrolidone kept at 80° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 6 was obtained.

### Example 7

The polyethylene porous film in Comparative Example 5 was immersed for 90 hours in N-methyl-2-pyrrolidone kept at 80° C. At that time, a liquid (N-methyl-2-pyrrolidone) in contact with a surface of the polyethylene porous film was constantly renewed by convection by heating. Then, N-methyl-2-pyrrolidone was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 7 was obtained.

### Example 8

The polyethylene porous film in Comparative Example 1 was immersed for 5 minutes in N,N-dimethylacetamide kept at 40° C. At that time, a liquid (N,N-dimethylacetamide) in contact with a surface of the polyethylene porous film was constantly renewed by convection by heating. Then, N,N-dimethylacetamide was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 8 was obtained.

### Example 9

The polyethylene porous film in Comparative Example 1 was immersed for 5 minutes in diethyl carbonate kept at 40° C. At that time, a liquid (diethyl carbonate) in contact with a surface of the polyethylene porous film was constantly renewed by convection by heating. Then, diethyl carbonate was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Example 9 was obtained.

### Comparative Example 6

The polyethylene porous film in Comparative Example 1 was immersed for 1 hour in 1-butanol kept at 80° C. At that time, a liquid (1-butanol) in contact with a surface of the polyethylene porous film was constantly renewed by convection by heating. Then, 1-butanol was replaced with acetone, the polyethylene porous film was taken out from acetone, and then was left still in a draft controlled to have a suction wind speed of 0.4 m/sec. and was dried therein. Thus, a nonaqueous electrolyte secondary battery separator in Comparative Example 6 was obtained.

<Production of Nonaqueous Electrolyte Secondary Battery>

With the use of the nonaqueous electrolyte secondary battery separators produced as above in Examples 1 through 9 and Comparative Examples 1 through 6, nonaqueous electrolyte secondary batteries were produced as follows.

(Cathode)

A commercially available cathode which was produced by applying LiNi_{0.5}Mn_{0.3}Co_{0.2}O₂/conductive material/PVDF (polyvinylidene fluoride) (weight ratio 92/5/3) to an aluminum foil was used. The aluminum foil of the commercially available cathode was cut so that a portion of the cathode where a cathode active material layer was formed had a size of 45 mm×30 mm and a portion where the cathode active material layer was not formed, with a width of 13 mm, remained around that portion. The cathode active material layer had a thickness of 58 μm and density of 2.50 g/cm³. The cathode had a capacity of 174 mAh/g.

(Anode)

A commercially available anode produced by applying graphite/styrene-1,3-butadiene copolymer/carboxymethyl cellulose sodium (weight ratio 98/1/1) to a copper foil was used. The copper foil of the commercially available anode was cut so that a portion of the anode where an anode active material layer was formed had a size of 50 mm×35 mm, and a portion where the anode active material layer was not formed, with a width of 13 mm, remained around that portion. The anode active material layer had a thickness of 49 μm and density of 1.40 g/cm³. The anode had a capacity of 372 mAh/g.

(Assembling)

In a laminate pouch, the cathode, the nonaqueous electrolyte secondary battery laminated separator, and the anode were laminated (provided) in this order so as to obtain a nonaqueous electrolyte secondary battery member. In this case, the cathode and the anode were positioned so that a whole of a main surface of the cathode active material layer of the cathode was included in a range of a main surface (overlapped the main surface) of the anode active material layer of the anode.

Subsequently, the nonaqueous electrolyte secondary battery member was put in a bag made by laminating an aluminum layer and a heat seal layer, and 0.25 mL of a nonaqueous electrolyte solution was poured into the bag. The nonaqueous electrolyte solution was an electrolyte solution at 25° C. obtained by dissolving LiPF₆ with a concentration of 1.0 mole per liter in a mixed solvent of ethyl methyl carbonate, diethyl carbonate, and ethylene carbonate in a volume ratio of 50:20:30. The bag was heat-sealed while a pressure inside the bag was reduced, so that a nonaqueous secondary battery was produced. The nonaqueous electrolyte secondary battery had a design capacity of 20.5 mAh.

<Results of Measurements of Physical Properties>

Nonaqueous electrolyte secondary batteries produced with use of the nonaqueous electrolyte secondary battery separators in Examples 1 through 9 and Comparative

Examples 1 through 6 were measured in terms of rate characteristic after charge and discharge cycles. The results of the measurements are shown in Table 1.

TABLE 1

| | Polyethylene | Solution in which | Condition for immersion | | | Rate characteristic |
|---|---|---|---|---|---|---|
| | porous film | film is immersed | Temperature (° C.) | Time of period | | after 100 cycles (%) |
| Example 1 | (A) | Acetone | 40 | 1 | hr | 69 |
| Example 2 | (A) | Acetone | 40 | 5 | min | 63 |
| Example 3 | (A) | NMP | 80 | 90 | hr | 62 |
| Example 4 | (A) | NMP | 80 | 1 | hr | 74 |
| Example 5 | (A) | NMP | 80 | 5 | min | 76 |
| Example 6 | (B) | NMP | 80 | 90 | hr | 87 |
| Example 7 | (C) | NMP | 80 | 90 | hr | 58 |
| Example 8 | (A) | DMAc | 40 | 5 | min | 61 |
| Example 9 | (A) | Diethyl carbonate | 40 | 5 | min | 61 |
| Comparative | (A) | Not immersed | | | | 52 |
| example 1 | | | | | | |
| Comparative | (A) | NMP | 125 | 10 | min | 45 |
| example 2 | | | | | | |
| Comparative | (A) | NMP | 125 | 1 | hr | 12 |
| example 3 | | | | | | |
| Comparative | (B) | Not immersed | | | | 28 |
| example 4 | | | | | | |
| Comparative | (C) | Not immersed | | | | 33 |
| example 5 | | | | | | |
| Comparative | (A) | 1-butanol | 80 | 1 | hr | 51 |
| example 6 | | | | | | |

NMP: N-methyl-2-pyrrolidone,
DMAc: N,N-dimethylacetamide

It was found from Table 1 that the nonaqueous electrolyte secondary battery separators in Examples 1 through 9 which used the polyolefin porous films having been immersed in the non-protonic polar solvents at no greater than 100° C. were superior to the nonaqueous electrolyte secondary battery separators in Comparative Examples 1 through 6 which used the polyolefin porous films produced otherwise, in terms of rate characteristics after 100 cycles of nonaqueous electrolyte secondary batteries using the nonaqueous electrolyte secondary battery separators.

### INDUSTRIAL APPLICABILITY

With the method of producing a nonaqueous electrolyte secondary battery separator in accordance with an embodiment of the present invention, a nonaqueous electrolyte secondary battery produced by using a nonaqueous electrolyte secondary battery separator obtained by the method has a high rate-characteristic-maintenance property. Accordingly, the present invention is usable in the field of producing nonaqueous electrolyte secondary batteries such as lithium ion secondary batteries, and are very useful.

1. A method of producing a nonaqueous electrolyte secondary battery separator, comprising the step of immersing a porous film containing polyolefin as a main component in a non-protonic polar solvent at no greater than 100° C., so as to modify the porous film.

2. The method as set forth in claim 1, wherein the non-protonic polar solvent is at a temperature of 30° C. to 100° C.

3. The method as set forth in claim 1, wherein the porous film is immersed while the polar solvent in contact with a surface of the porous film is renewed.

4. The method as set forth in claim 1, further comprising the step of removing, from the porous film having been immersed in the non-protonic polar solvent at no greater than 100° C., the polar solvent,
in the step of removing the polar solvent, the porous film having been immersed in the polar solvent being immersed in a solvent different from the polar solvent.

5. The method as set forth in claim 1, further comprising the step of removing, from the porous film having been immersed in the non-protonic polar solvent at no greater than 100° C., the polar solvent,
in the step of removing the polar solvent, a gas in contact with a surface of the porous film having been immersed in the polar solvent being renewed.

6. The method as set forth in claim 5, wherein the gas is a nitrogen gas.
